(19) United States
(12) Patent Application Publication
(10) Pub. No.: US 2025/0179855 A1
(43) Pub. Date: Jun. 5, 2025

(54) DRIVE ARRANGEMENT FOR ADJUSTING A FLAP OF A MOTOR VEHICLE

(71) Applicant: Brose Fahrzeugteile SE &Co. Kommanditgesellschaft, Bamberg, Bamberg (DE)

(72) Inventors: Leo Kroener, Bischberg (DE); Florian Woelker, Hausen (DE); Jiri Beinstein, Lichnov (DE); Christoph Haberberger, Goessweinstein (DE); Rainer Wirths, Wuppertal (DE); Felix Eichhorn, Schesslitz (DE); Harald Hugel, Bamberg (DE); Adam Laczo, Bischberg (DE); Vitali Wendland, Bamberg (DE)

(21) Appl. No.: 18/524,995

(22) Filed: Nov. 30, 2023

(51) Int. Cl. E05F 15/63

(52) U.S. Cl. CPC E05F 15/614; E05F 15/63; E05Y 2900/544

(57) ABSTRACT

A drive arrangement for adjusting a flap of a vehicle, wherein the flap is mounted to a vehicle body such that the flap is pivotally movable between an open position and a closed position, wherein the drive arrangement comprises a drive unit for moving the flap between the open position and the closed position, wherein the drive unit comprises an electric drive, a unit housing, and an output shaft, which is rotatable mounted in the housing, wherein the output shaft comprises a shaft interface for connecting the output shaft to the vehicle body. The drive arrangement can include a mounting adapter for indirect mounting of the drive unit to the flap and that the mounting adapter comprises an adapter interface, with which the mounting adapter is attached to the drive unit and that the mounting adapter comprises a further adapter interface for attachment of the mounting adapter to the flap.

### FIELD OF THE TECHNOLOGY

Various embodiments relate to a drive arrangement for adjusting a flap of a motor vehicle, to a motor vehicle and to a method for installing the drive arrangement.

### SUMMARY

The drive arrangement in question can be generally used in different kinds of motor vehicles and thus for adjusting different kinds of flaps. For example, the motor vehicle might be a pickup truck with a flap, which can be moved into an open position and a closed position. The adjustment of the flap happens under the influence of the weight force of the flap, wherein for pickup trucks, this particularly influences the movement from the open position to the closed position. Due to the fact, that the weight of the flap is often significant and might be even raised by different additional arrangements, which are attached to the flap (like electric locking devices, etc.), high requirements on the drive arrangement and on the attachment of the drive arrangement to the flap are imposed.

The known prior art (DE 10 2021 101 785 A1) that builds the basis of some embodiments is related to a drive arrangement. The drive arrangement comprises a drive unit for moving the flap between the open position and the closed position. The drive unit itself comprises an electric drive, a unit housing and an output shaft. The electric movement of the electric drive effects the movement of the flap and the unit housing houses the electric drive and further components of the drive unit (like a transmission or the like). The output shaft is rotatable mounted in the unit housing and comprises a shaft interface, with which the output shaft is connectable to a vehicle body of a motor vehicle. The known drive arrangement is attached to the flap, wherein this is achieved by attaching the unit housing directly to a bottom of the flap. Since the output shaft is attached to the vehicle body and the unit housing is attached to the flap, a relative movement of the flap in relation to the vehicle body can be effected accordingly.

Against this background, it can be understood that the connection between to the unit housing and the flap as well as the connection between the output shaft and the vehicle body are crucial for functionality reasons. Here, a failure of these connections may lead to an overall failure of the drive arrangement. While the connection between the output shaft and the vehicle body often does not lead to essential challenges, the connection between the unit housing and the flap, namely the attachment of the unit housing to the flap, might be challenging and elaborately in some cases. For example, the flap often only provides certain attachment points, on which the drive unit has to be attached, and often only provides a certain assembly space inside the flap, in which the drive unit has to be arranged. The overall design of the drive arrangement and in particular the unit housing has to be adjusted accordingly. Since the attachment points and the assembly space may depend on the kind of flap and thus be different for different flaps, suitable and individual adjustments of the drive arrangement and in particular of the unit housing, which come along with individual construction work, are quite often necessary.

Various embodiments are thus based on the problem of improving the known drive arrangement regarding its usability for different kinds of flaps. In particular, a drive arrangement is provided, which can easily be attached to different kinds of flaps, wherein suitable and individual adjustments regarding the drive unit and particularly the unit housing are simplified.

The above-noted object is solved by the features as described herein.

A main aspect of some embodiments is that the drive arrangement comprises a mounting adapter, wherein the drive unit is mountable to a flap of a motor vehicle by the mounting adapter.

Instead of direct mounting of the drive unit to the flap by attaching the unit housing directly to a bottom of the flap (like it is the case in the state of the art), the drive unit, in particular the unit housing, is indirectly mountable to the flap, in particular to a side wall of the flap, by using the mounting adapter. As a result, if the drive arrangement shall be used for different kinds of flaps, effortful adjustments to the unit housing can be avoided. Instead, the mounting adapter is adjusted with respect to the structural circumstances, in particular with respect to the assembly space in the flap, attachment points of the flap, the design of the drive unit, the orientation of the drive unit inside the flap, etc. If any adjustments of the drive unit, in particular of the unit housing, are necessary, they are relatively simple to realize. The mounting adapter comprises an adapter interface for connecting the mounting adapter to the drive unit, particularly the unit housing, and the mounting adapter comprises a further adapter interface for connecting the mounting adapter to the flap, in particular to the side wall of the flap. This may further simplify the adjustability of the mounting adapter.

The mounting adapter is particularly designed such that the drive unit is mountable to the flap in a rotatably secured way, which means that a relative movement of the unit housing with respect to the flap is prevented. As a result, when the flap is moved pivotally between the open position and the closed position, the unit housing and the mounting adapter are moved with the flap.

In detail, it is proposed that the drive arrangement comprises a mounting adapter for, particularly rotationally secured, mounting of the drive unit to the flap and that the mounting adapter comprises an adapter interface, with which the mounting adapter is attached to the drive unit and that the mounting adapter comprises a further adapter interface for attachment of the mounting adapter to the flap.

According to various embodiments, the mounting adapter of the drive arrangement is designed separately with respect to the drive unit and in particular with respect to the unit housing. Thus, the mounting adapter can easily be adjusted with respect to the flap, on which the drive unit shall be attached, particularly regarding the assembly space and the attachment point or attachment points, and with respect to the drive unit, without significant adjustments regarding the drive unit and particularly the unit housing. A sheet metal part can be easily manufactured and adjusted, but is still functional. A full metal part can be manufactured especially stable such that particularly the drive arrangement can be used for adjusting very heavy-weighted flaps.

Various embodiments include a detachably attached mounting adapter. Here, the mounting adapter is removable from the drive unit, particularly from the unit housing, what may lead to advantages regarding maintenance or service actions. A screw connection and/or a form-fit connection may be designed relatively simple, but functional at the same time. Various embodiments include the screw connection as well as the form-fit connection.

In various embodiments, it is intended that the mounting adapter is rotationally secured in relation to the unit housing by an anti-rotation arrangement. Although this may be generally reached by different designs, a form-fit connection for preventing rotational movement of the mounting adapter in relation to the unit housing may be especially reliable and thus may improve the overall operational reliability of the drive arrangement. Various embodiments include an anti-rotation element or elements and of a counterpart anti-rotation element or elements.

According to various embodiments, the drive arrangement comprises an angle mounting aid, which simplifies the attachment of the mounting adapter to the unit housing with regard to the relative angular position. The angle mounting aid might be formed by the anti-rotation element or elements and the counterpart anti-rotation element or elements such that additional components are not necessarily needed.

In various embodiments, the attachment of the mounting adapter is simplified with regard to the alignment of the mounting adapter in a plane, which is orthogonally orientated to the axial direction of the output shaft. A free from play alignment by a centering element and a counterpart centering element provides a high accuracy regarding the alignment of the mounting adapter.

By arranging the adapter interface and the further adapter interface of the mounting adapter with an offset, adjustments to the mounting adapter with regard to the flap and the drive unit are further simplified. For example, certain distances between the drive unit and an attachment point or attachment points of the flap might be overcome accordingly.

Various embodiments relate to a motor vehicle comprising a vehicle body, a flap and a drive arrangement as provided.

All explanations given with regard to the drive arrangement are fully applicable.

Various embodiments relate to a method for installing the drive arrangement as provided to a motor vehicle, particularly to a flap of the motor vehicle. The method can include selecting and/or constructing the mounting adapter under consideration of the structural circumstances, in some embodiments, regarding the assembly space inside the flap and/or the drive unit and/or the orientation of the flap in relation to the vehicle body, in particular the unit housing.

All explanations given with regard to the drive arrangement as provided and the Motor vehicle as provided are fully applicable.

Various embodiments provide a drive arrangement for adjusting a flap of a motor vehicle, wherein the flap is mounted to a vehicle body such that the flap is pivotally movable in relation to the vehicle body between an open position and a closed position, wherein the drive arrangement comprises a drive unit for moving the flap between the open position and the closed position, wherein the drive unit comprises an electric drive, a unit housing, in which the electric drive is housed, and an output shaft, which is rotatable mounted in the unit housing, wherein the output shaft comprises a shaft interface for connecting the output shaft to the vehicle body, wherein the drive arrangement comprises a mounting adapter for mounting of the drive unit to the flap and that the mounting adapter comprises an adapter interface, with which the mounting adapter is attached to the drive unit and that the mounting adapter comprises a further adapter interface for attachment of the mounting adapter to the flap.

In various embodiments, the mounting adapter is designed separately with respect to the drive unit, in some embodiments, that the mounting adapter comprises a sheet metal part, which particularly represents a main body of the mounting adapter, or, that the mounting adapter comprises a full metal part, which particularly represents a main body of the mounting adapter.

In various embodiments, the mounting adapter is detachably attached to the drive unit, in some embodiments, that the mounting adapter is attached to the unit housing by the adapter interface using a screw connection with at least one screw element, and/or, that the mounting adapter is attached to the unit housing by the adapter interface using a form-fit connection with at least one form-fit element.

In various embodiments, the screw connection secures the mounting adapter in its relative axial position in relation to the drive unit, in some embodiments, that the screw element is installed in the axial direction of the output shaft, and/or, that the form-fit connection secures the mounting adapter in its relative axial position in relation to the drive unit.

In various embodiments, a relative rotational movement of the mounting adapter and the unit housing is prevented by an anti-rotation arrangement, in some embodiments, that the adapter interface comprises at least one anti-rotation element and that the unit housing comprises at least one counterpart anti-rotation element and that the anti-rotation element and the counterpart anti-rotation element form the anti-rotation arrangement, further in some embodiments, that the anti-rotation element and the counterpart anti-rotation element are designed such that a further form-fit connection is formed.

In various embodiments, the anti-rotation element is designed as a recess or as a projection and that the counterpart anti-rotation element is designed as a projection or rather as a recess, wherein the projection engages with the recess, or, that the adapter interface comprises several anti-rotation elements and the unit housing comprises several counterpart anti-rotation elements and that the anti-rotation elements and the counterpart anti-rotation elements are designed such that a gear teeth connection is formed, which prevents the rotational movement of the mounting adapter relative to the unit housing.

In various embodiments, the mounting adapter is attached to the unit housing in a definite relative angular position, which is determined by an angle mounting aid, in some embodiments, that the anti-rotation element or the anti-rotation elements and the counterpart anti-rotation element or rather the counterpart anti-rotation elements form the angle mounting aid.

In various embodiments, the adapter interface comprises a centering element and that the unit housing comprises a counterpart centering element and that the centering element and the counterpart centering element are in contact such that the relative position of the mounting adapter in relation to the unit housing in a plane, which is orthogonally orientated with regard to the axis of rotation of the output shaft, is determined, particularly free from play, in some embodiments, that the centering element is designed as a centering recess of the sheet metal part and that the counterpart centering element is designed as a centering projection of the unit housing, or, that the centering element is formed by the anti-rotation elements and the counterpart centering element is formed by the counterpart anti-rotation elements.

In various embodiments, the adapter interface and the further adapter interface are arranged to each other with an offset, wherein the offset particularly determines the relative attachment position, in which the drive unit can be attached to the flap, in some embodiments, that the sheet metal part of the mounting adapter comprises a first section, a middle section and a second section and that the adapter interface is arranged on the first section and the further adapter interface is arranged on the second section and that the middle section connects the first section and the second section, wherein the offset is at least partly determined by the length and/or orientation of the middle section.

Various embodiments provide a motor vehicle comprising a vehicle body, a flap and a drive arrangement as described herein.

Various embodiments provide a method for installing the drive arrangement as described herein to a motor vehicle, particularly a flap of the motor vehicle, wherein the method particularly comprises selecting and/or constructing the mounting adapter under consideration of the structural circumstances, such as, regarding the assembly space inside the flap and/or the drive unit and/or the orientation of the flap in relation to the vehicle body.

### BRIEF DESCRIPTION OF THE DRAWINGS

In the following, embodiments are explained with respect to the drawing. The drawing shows in

FIG. 1 a drive arrangement as proposed with a mounting adapter, wherein the drive arrangement is attached to a flap of a motor vehicle, in a perspective view and in a detailed perspective view,

FIG. 2 the drive arrangement according to FIG. 1 in a partly exploded view, and

FIG. 3 further embodiments of the drive arrangement as proposed with a different design of the mounting adapter, wherein in a) a screw connection is used for attaching the drive unit to the flap by the mounting adapter and wherein in b) a form-fit connection is used for attaching the drive unit to the flap by the mounting adapter.

### DETAILED DESCRIPTION

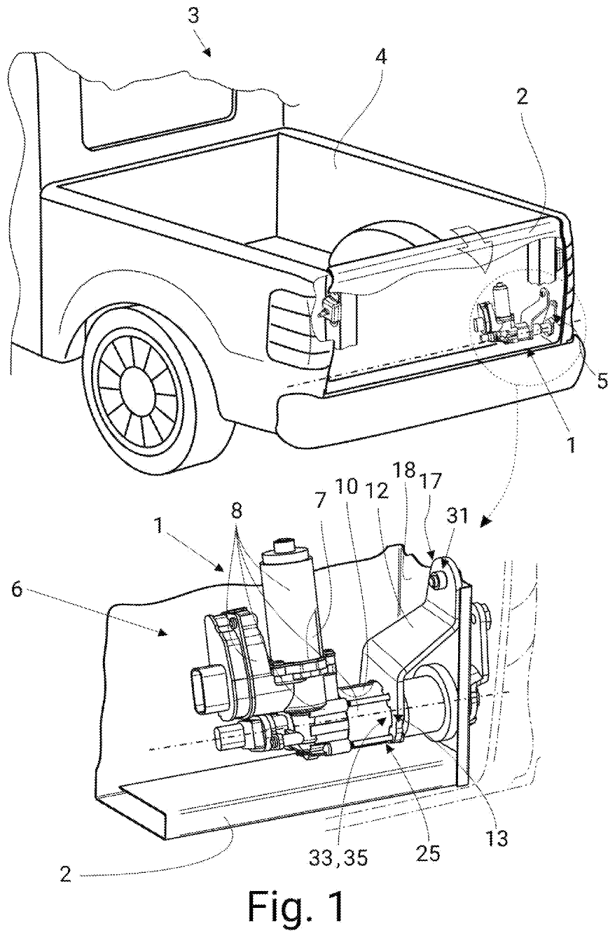

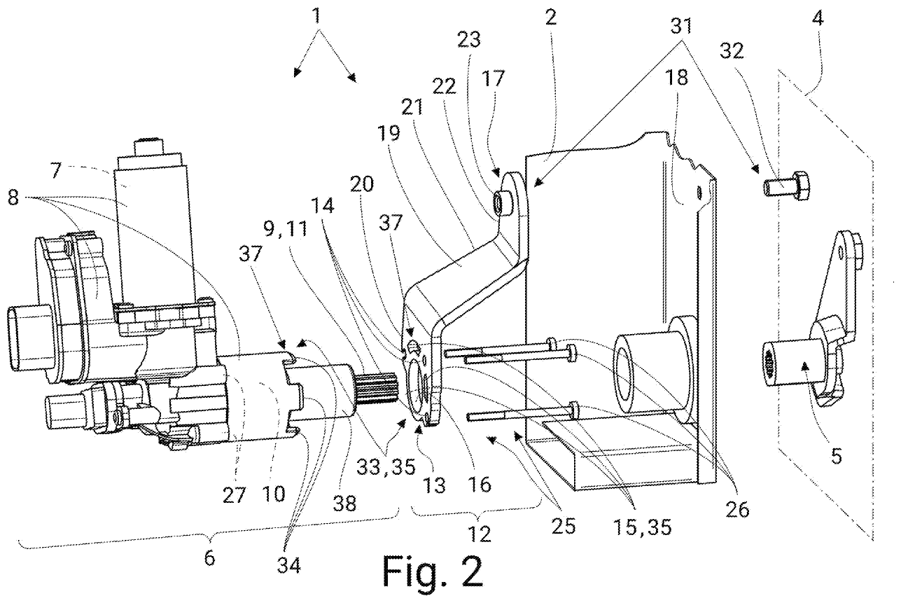

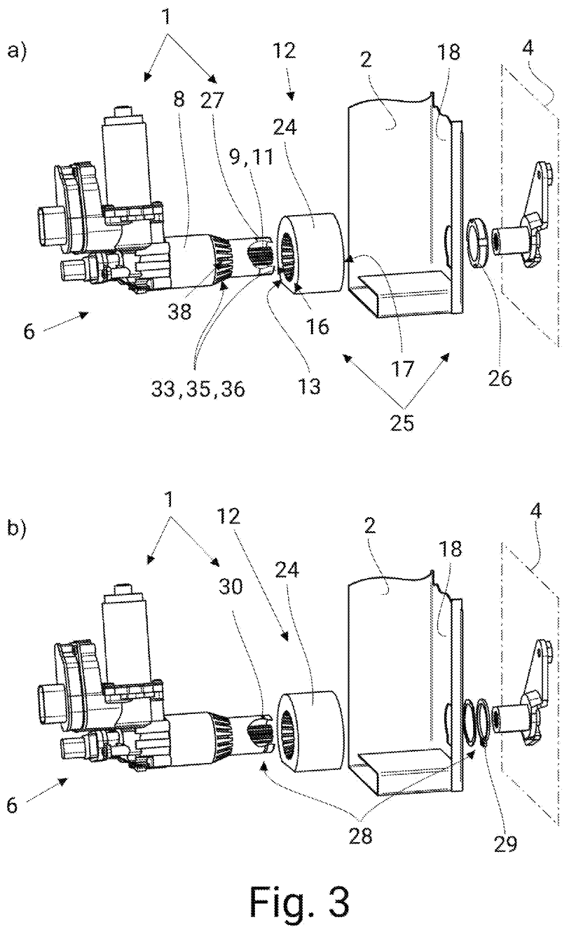

Proposed is a drive arrangement 1 for adjusting a flap 2 of a motor vehicle 3. The drive arrangement 1 is shown in different embodiments, wherein one embodiment is shown in FIGS. 1 and 2 and other embodiments are shown in FIGS. 3a) and 3b).

The flap 2 is mounted to a vehicle body 4, as it can be seen in FIG. 1, such that the flap 2 is pivotally movable in relation to the vehicle body 4 between an open position and a closed position. In various embodiments, the vehicle body 4 comprises a flap mount assembly 5 for mounting the flap 2 (FIGS. 2, 3a), 3b)). The vehicle body 4 relates to the motor vehicle 3 and might be a chassis. The motor vehicle 3 can be a pickup truck. The flap 2 can be designed as a downward openable flap 2.

The drive arrangement 1 comprises a drive unit 6 for moving the flap 2 between the open position and the closed position. Thus, the drive unit 6 enables automatic closing and/or opening of the flap 2, for example in reaction of a respective control signal.

The drive unit 6 comprises at least an electric drive 7, a unit housing 8 and an output shaft 9. The electric drive 7 is housed in the unit housing 8. The output shaft 9 is at least partly also housed in the unit housing 8 and is particularly rotatable mounted in the unit housing 8. The output shaft 9 thus can rotate about an axis of rotation, which can be oriented in horizontal direction (in a assembly condition of the drive arrangement 1, like it is shown in FIG. 1). In various embodiments, the axis of rotation of the output shaft 9 and the pivoting axis of the flap 2 are coaxially arranged. The electric drive 7 may comprise a motor shaft, which is arranged orthogonally with respect to the axis of rotation of the output shaft 9.

Generally, it is possible that the drive unit 6 comprises further components 10 (which can be partly seen in FIG. 1), like a transmission arrangement, a clutch arrangement or the like. The further components 10 may be housed in the unit housing 8, like it is the case for some embodiments.

The output shaft 9 comprises a shaft interface 11 for connecting the output shaft 9 to the vehicle body 4. The output shaft 9 and the shaft interface 11 can be best seen in FIGS. 2, 3a) and 3b). The output shaft 9 and the vehicle body 4 are connected such that a rotational movement of the output shaft 9 in relation to the vehicle body 4 is prevented (in the assembly condition of the drive arrangement 1, like it is shown in FIG. 1).

Essential is that the drive arrangement 1 comprises a mounting adapter 12 for mounting of the drive unit 6, particularly of the unit housing 8, to the flap 2. Instead of direct mounting of the drive unit 6 to the flap 2, for example by attaching the unit housing 8 to the flap 2, like it is the case for drive arrangements 1 in the state of the art, the drive unit 6 is mounted indirectly to the flap 2 by using the mounting adapter 12 (FIG. 1). It can be that the mounting adapter 12 enable rotationally secured mounting of the drive unit 6, particularly the unit housing 8, to the flap 2. This enables that during opening and/or closing of the flap 2 a relative movement of the unit housing 8 in relation to the flap 2, particularly about the axis of rotation of the output shaft 9, is prevented. The mounting adapter 12 is fully arranged outside of the unit housing 8. In some embodiments, the mounting adapter 12 and/or the drive unit 6 can be fully arranged inside of the flap 2.

The mounting adapter 12 comprises an adapter interface 13, with which the mounting adapter 12 is attached to the drive unit 6, in particular to the unit housing 8. The adapter interface 13 is designed such that the mounting adapter 12 can be attached to the drive unit 6, wherein it may comprise screw recesses 14, anti-rotation elements 15 and/or centering elements 16 (FIG. 2). The adapter interface 13 is described in more detail later.

The mounting adapter 12 comprises a further adapter interface 17, with which the mounting adapter 12 is attached or attachable to the flap 2. The further adapter interface 17 may be designed such that the mounting adapter 12 can be detachably attached to the flap 2 (like it is the case for the embodiment according to FIGS. 1, 2) or can be permanently attached to the flap 2 (like it is the case for the embodiments according to FIGS. 3a), 3b)).

Generally, the mounting adapter 12 is designed to orientate the drive unit 6, particularly the unit housing 8, with respect to the flap 2. The relative position of the drive unit 6, in particular the unit housing 8, with respect to the flap 2 thus depends on the spatial design of the mounting adapter 12.

As it can be seen in FIG. 1, the mounting adapter 12 is designed such that the drive unit 6, in particular the unit housing 8, is attachable to a side wall 18 of the flap 2. The side wall 18 of the flap 2 is orientated vertically, in both the open position and the closed position of the flap 2. The side wall 18 of the flap 2 is orientated orthogonal to the axial direction of the output shaft 9. In the assembly condition, the mounting adapter 12 is arranged between the unit housing 8 and the side wall 18 of the flap 2 with regard to the axial direction of the output shaft 9.

For proper adjustment of the mounting adapter 12 to the structural circumstances, it is proposed that the mounting adapter 12 is designed separately with respect to the drive unit 6, in particular with respect to the unit housing 8, as shown in FIGS. 2, 3a) and 3b). Thus, the mounting adapter 12 might be manufactured independently of the drive unit 6, in particular in different manufacturing processes. The drive unit 6 might be preassembled, wherein the mounting adapter 12 might be attached to the drive unit 6 after preassembling of the same. “Designed separately” in this context means that the mounting adapter 12 is designed as an individual part of the drive arrangement 1, in particular that the mounting adapter 12 is not designed as a part of the drive unit 6 and is particularly not designed as a part of the unit housing 8. The mounting adapter 12 can also be designed separately with respect to the flap 2.

According to the embodiment in FIGS. 1, 2, the mounting adapter 12 comprises a sheet metal part 19, which particularly represents a main body of the mounting adapter 12. The main body of the mounting adapter 12 is generally the largest part of the mounting adapter 12. In various embodiments, the mounting adapter 12 comprises the sheet metal part 19, which comprises a first section 20, a middle section 21 and a second section 22, and a threaded part 23, which is attached, such as welded, to the sheet metal part 19. The first section 20, the middle section 21 and the second section 22 are described later. The sheet metal part 19 might be produced by punching and/or cutting and/or bending. Generally, the sheet metal part 19 comprises a certain height, a certain depth and a certain width, wherein the width of the sheet metal part 19 is relatively small compared to the height and/or the depth of the sheet metal part 19.

According to the embodiments in FIGS. 3a) and 3b), the mounting adapter 12 comprises a full metal part 24, which particularly represents a main body of the mounting adapter 12. The full metal part 24 may be produced by casting and/or milling and/or lathing.

Although the mounting adapter 12 generally can be permanently attached to the drive unit 6, for example by a welding connection or an adhesive connection, it is here proposed that the mounting adapter 12 can be detachably attached to the drive unit 6, in particular to the unit housing 8. “Detachably attached” in this context means that the drive unit 6 can be non-destructively detached from the mounting adapter 12, for example by a mechanic using tools during a maintenance or service routine.

According to the embodiments shown in FIGS. 2 and 3a), the mounting adapter 12 can be attached to the unit housing 8 by the adapter interface 13 using a screw connection 25 with at least one screw element 26. The screw element 26 might be a fastening screw (FIG. 2). The fastening screw may extend through the mounting adapter 12, wherein the adapter interface 13 particularly comprises at least one screw recess 14. In various embodiments, the screw connection 25 comprises three screw elements 26. Alternatively, the screw element 26 might be a nut, particularly a slotted nut (FIG. 3a)).

The screw element 26 may be screwed to at least one counterpart screw element 27. The counterpart screw element 27 is, in some embodiments, a part of the drive unit 6, in particular a part of the unit housing 8. According to FIG. 2, the counterpart screw element 27 may be an internal thread, in which particularly the fastening screw is screwed. According to FIG. 3a), the counterpart screw element 27 may be an external thread, on which particularly the nut is screwed.

According to the embodiment shown in FIG. 3b), the mounting adapter 12 is attached to the unit housing 8 by the adapter interface 13 using a form-fit connection 28 with at least one form-fit element 29. The form-fit element 29 might be a locking ring, particularly a circlip (FIG. 3b)). The drive unit 6, in particular the unit housing 8, may comprise a counterpart form-fit element 30, like a circumferential groove, on which the form-fit element 29 is attached.

Regarding the screw connection 25, it is proposed that the screw connection 25 secures the mounting adapter 12 in its relative axial position in relation to the drive unit 6, particularly in relation to the unit housing 8. The “relative axial position” in this context is the relative position of the mounting adapter 12 in relation to the drive unit 6, particularly the unit housing 8, with regard to the axial direction of the output shaft 9. As a result, the mounting adapter 12 cannot move relatively to the drive unit 6, particularly the unit housing 8, in the axial direction of the output shaft 9. With other words, the screw connection 25 secures the mounting adapter 12 in the axial direction of the output shaft 9 relatively to the drive unit 6, in particular to the unit housing 8. In FIG. 1, for example, the screw connection 25 thus prevents the unit housing 8 from moving leftward sin the axial direction of the output shaft 9, and thus relative to the mounting adapter 12. It can be that the screw element 26 is installed in the axial direction of the output shaft 9 (FIGS. 2 and 3a)).

Regarding the form-fit connection 28, it is proposed that the form-fit connection 28 secures the mounting adapter 12 in its relative axial position in relation to the drive unit 6, particularly in relation to the unit housing 8. The same result as described in context with the screw connection 25 might be reached.

For the embodiments shown in FIGS. 3a) and 3b), the screw connection 25 or rather the form-fit connection 28 secures the mounting adapter 12 in relation to the drive unit 6 in its relative axial direction and also secures the drive arrangement 1 in relation to the flap 2 in the axial direction of the output shaft 9. Here it is possible that the mounting adapter 12 is permanently attached to the flap 2, for example by the further adapter interface 17 using a welding connection or an adhesive connection.

For the embodiment shown in FIGS. 1 and 2, it can be that the mounting adapter 12 is detachably attachable to the flap 2 by the further adapter interface 17 using a further screw connection 31. The further screw connection 31 comprises a further screw element 32, as can be seen in FIG. 2. In various embodiments, the further adapter interface 17 comprises the threaded part 23, in which the further screw element 32 can be screwed in. In various embodiments, the further screw connection 31 secures the mounting adapter 12 in relation to the flap 2 in the axial direction of the output shaft 9.

It is generally possible that the mounting adapter 12 is attached to the unit housing 8 such that a relative rotational movement of the mounting adapter 12 in relation to the unit housing 8 is already prevented by the screw connection 25 and/or the form-fit connection 28 and particularly by the resulting frictional forces. However, according to another embodiment, it is particularly proposed that a relative rotational movement of the mounting adapter 12 and the unit housing 8 is prevented by an anti-rotation arrangement 33, which is particularly designed separately to the screw connection 25 and/or the form-fit connection 28. The “relative rotational movement” in this context means the rotational movement of the mounting adapter 12 in relation to the unit housing 8 about the axis of rotation of the output shaft 9.

In this context, the adapter interface 13 can include at least one anti-rotation element 15 and that the unit housing 8 comprises at least one counterpart anti-rotation element 34. The anti-rotation element 15 and the counterpart anti-rotation element 34 form the anti-rotation arrangement 33. In FIG. 2, the adapter interface 13 comprises at least two, here three, anti-rotation elements 15 and the unit housing 8 comprises at least two, here three, counterpart anti-rotation elements 34. In FIGS. 3a) and 3b), the adapter interface 13 comprises several anti-rotation elements 15 and the unit housing 8 comprises several counterpart anti-rotation elements 34, which are described in the following.

It can be that the anti-rotation element 15 or the anti-rotation 14lements and the counterpart anti-rotation element 34 or rather the counterpart anti-rotation elements 34 are designed such that a further form-fit connection 35 is formed. This is the case for the embodiments, which are shown in FIGS. 1, 2 and 3a) and 3b). Here, it is possible that the further form-fit connection 35 is formed in the course of moving the mounting adapter 12 relatively to the unit housing 8 in the axial direction of the output shaft 9, for example during the installation of the mounting adapter 12 to the drive unit 6, in particular to the unit housing 8.

Regarding the design of the anti-rotation element 15 and the counterpart anti-rotation element 34, it is proposed that the anti-rotation element 15 is designed as a recess, like a clearance hole, and that the counterpart anti-rotation element 34 is designed as a projection, as it can be seen in FIG. 2. The projection engages with the recess, in particular in the axial direction of the output shaft 9. Thus, the further form-fit connection 35 is formed. Although, it can be that the anti-rotation element 15 is designed as a recess and the counterpart anti-rotation element 34 is designed as a projection, it is also possible that the anti-rotation element 15 is designed as a projection and the counterpart anti-rotation element 34 is designed as a recess.

In case of more than one anti-rotation element 15 and more than one counterpart anti-rotation element 34 (FIGS. 1 and 2), each can be designed as a recess or rather a projection.

As described beforehand in context with the embodiment according to FIGS. 1 and 2, the adapter interface 13 comprises at least two, here three, anti-rotation elements 15, which each are designed as a recess. The unit housing 8 comprises at least two, here three, counterpart anti-rotation elements 34, which are designed as a projection each. In various embodiments, the counterpart anti-rotation element 34 or counterpart anti-rotation elements 34 particularly extend or extends essentially in the axial direction of the output shaft 9. The counterpart anti-rotation element 34 or counterpart anti-rotation elements 34 also extend or extends in a peripheral direction with regard to the axis of rotation of the output shaft 9. In case of several counterpart anti-rotation elements 34, which are designed as projections, like its the case for the embodiment in FIGS. 1 and 2, it is possible that the counterpart anti-rotation elements 34 are arranged and designed crown-like.

As it can be seen in FIGS. 3a) and 3b), it is also possible that the adapter interface 13 comprises several anti-rotation elements 15 and the unit housing 8 comprises several counterpart anti-rotation elements 34, wherein the anti-rotation elements 15 and the counterpart anti-rotation elements 34 are designed such that the further form-fit connection 35 is formed, in some embodiments in form of a gear teeth connection 36. The further form-fit connection 35, here in form of the gear teeth connection 36, prevents the rotational movement of the mounting adapter 12 relative to the unit housing 8. The anti-rotation elements 15 might be arranged and designed bevel-gearlike.

According to another embodiment it is proposed, that the mounting adapter 12 is attached to the unit housing 8 in a definite relative angular position, which is determined by an angle mounting aid 37. The “relative angular position” is the angular position of the mounting adapter 12 in relation to the unit housing 8 with respect to the axis of rotation of the output shaft 9. This position is “definite” such that the mounting adapter 12 can be attached to the unit housing 8 in a, particularly unique, relative angular position, which is determined by the angle mounting aid 37 accordingly. With other words, the angle mounting aid 37 is designed such that the mounting adapter 12 can be attached to the unit housing 8 in a definite relative angular position.

It is generally possible that the angle mounting aid 37 comprises mounting aid elements or the like for alignment of the mounting adapter 12 regarding its relative angular position. However, it can be that the anti-rotation element 15 or the anti-rotation elements 15 and the counterpart anti-rotation element 34 or rather the counterpart anti-rotation elements 34 form the angle mounting aid 37. This is the case for the embodiment, which is shown in FIGS. 1 and 2. In various embodiments, the anti-rotation elements 15 are arranged and designed in a certain pattern, wherein the counterpart anti-rotation elements 34 are arranged in a certain counterpart pattern.

According to another embodiment it is proposed that the adapter interface 13 comprises a centering element 16 and that the unit housing 8 comprises a counterpart centering element 38. The centering element 16 and the counterpart centering element 38 are in contact such that the relative position of the mounting adapter 12 in relation to the unit housing 8 in a plane, which is orthogonally orientated with regard to the axis of rotation of the output shaft 9, is determined, particularly free from play. Here (FIG. 1), the plane is a vertical plane. With other words, the mounting adapter 12 is aligned with respect to the axis of rotation of the output shaft 9.

For the embodiment of FIGS. 1 and 2, the centering element 16 is designed as a centering recess, like a clearance hole, which particularly is circular. The counterpart centering element 38 is designed as a centering projection of the unit housing 8, in some embodiments the centering projection is cylindrical. It is possible that the counterpart centering element 38 enables centering of the drive arrangement 1, in particular the output shaft 9, in relation to the flap 2.

Although the centering element 16 and the counterpart centering element 38 might be designed separately from the anti-rotation elements 15 or rather the counterpart anti-rotation elements 34 (like it is the case for the embodiment according to FIGS. 1, 2), it is alternatively possible that the centering element 16 is formed by the anti-rotation elements 15 and the counterpart centering element 38 is formed by the counterpart anti-rotation elements 34, which form the further form-fit connection 35, in some embodiments in form of the gear teeth connection 36. This is the case for the embodiments according to FIGS. 3a), 3b). For centering reasons, the counterpart anti-rotation elements 34 may be designed and arranged in a cone-shape and thus form the counterpart centering element 38, wherein the anti-rotation elements 15 may be designed and arranged in a counterpart cone-shape and thus form the centering element 16. Because of the cone-shaped counterpart centering element 38 and the counterpart cone-shaped centering element 16, as shown in FIGS. 3a), 3b), the relative position of the mounting adapter 12 in relation to the unit housing 8 in the plane, which is orthogonally orientated with regard to the axis of rotation of the output shaft 9, is determined.

According to one embodiment it is furthermore proposed that the adapter interface 13 and the further adapter interface 17 are arranged to each other with an offset, wherein the offset can determine the relative attachment position, in which the drive unit 6 can be attached to the flap 2. The offset can include an axial offset and/or a transverse offset. The axial offset is an offset in the axial direction of the output shaft 9, wherein the transverse offset is an offset in a direction, which is orthogonally orientated to the axial direction of the output shaft 9. In some embodiments (FIG. 2), the offset is designed such that a force, which results from a torque, which is effected by the drive unit 6 around the axis of rotation of the output shaft 9, can be induced to the flap 2 by the further adapter interface 17 in a certain distance, wherein the transverse offset is particularly at least 1 cm, at least 3 cm, or at least 5 cm.

In some embodiments, the sheet metal part 19 of the mounting adapter 12 comprises a first section 20, a middle section 21 and a second section 22, as it can be seen in FIG. 2. The adapter interface 13 is arranged, particularly formed, on the first section 20 and the further adapter interface 17 is arranged, particularly formed, on the second section 22. The middle section 21 connects the first section 20 and the second section 22, wherein the offset is at least partly, particularly mostly, determined by the length and/or orientation of the middle section 21. The middle section 21 may be designed flat. The first section 20 and/or the second section 22 may be designed flat. In some embodiments, the first section 20 is an end section of the sheet metal part 19 and/or the second section 22 is an end section of the sheet metal part 19.

In various embodiments, the first section 20 and the second section 22 are arranged essentially in parallel planes to each other, which are particularly orientated orthogonally to the axial direction of the output shaft 9. The middle section 21, in some embodiments, extends transversally to the first section 20 and the second section 22. In some embodiments, the middle section 21 is connected in an angle with the first section 20 and/or with the second section 22. However, it is also thinkable that the first section 20 and the second section 22 are arranged in the same plane, wherein the middle section 21 is arranged in the same plane as well. The middle section 21 comprises a length of at least 1 cm, of at least 3 cm, or of at least 5 cm.

Another teaching which is of equal importance relates to a motor vehicle 3 comprising a vehicle body 4, a flap 2 and a drive arrangement 1 as provided. The drive arrangement 1 thus comprises one or several of the features described beforehand.

All explanations given with regard to the drive arrangement 1 are thus fully applicable.

The flap 2 can include a side wall 18. The side wall 18 of the flap 2 is orientated vertically, in both the open position and the closed position of the flap 2. The side wall 18 of the flap 2 is orientated orthogonal to the axial direction of the output shaft 9. The side wall 18 may comprise an attachment point. The drive arrangement 1 is attached to the flap 2, in particular to the side wall 18 of the flap 2, wherein the drive unit 6 is attached by the mounting adapter 12, in particular rotationally secured such that a relative rotation of the unit housing 8 in relation to the flap 2 about the axis of rotation of the output shaft 9 is prevented.

Another teaching which is of equal importance relates to a method for installing the drive arrangement 1 as provided to a motor vehicle 3, particularly to a flap 2 of the motor vehicle 3. The drive arrangement 1 comprises one or several of the features described beforehand.

All explanations given with regard to the drive arrangement 1 as provided and the Motor vehicle 3 as provided are fully applicable.

The method can include selecting and/or constructing the mounting adapter 12 under consideration of the structural circumstances, in some embodiments, regarding the assembly space inside the flap 2 and/or the drive unit 6, in particular the unit housing 8, and/or the orientation of the flap 2 in relation to the vehicle body 4. The method can include mounting, particularly rotationally secured mounting, of the drive unit 6 to the flap 2 by using the mounting adapter 12.

1. A drive arrangement for adjusting a flap of a motor vehicle, wherein the flap is mounted to a vehicle body such that the flap is pivotally movable in relation to the vehicle body between an open position and a closed position, wherein the drive arrangement comprises a drive unit for moving the flap between the open position and the closed position, wherein the drive unit comprises an electric drive, a unit housing, in which the electric drive is housed, and an output shaft, which is rotatable mounted in the unit housing, wherein the output shaft comprises a shaft interface for connecting the output shaft to the vehicle body,
wherein the drive arrangement comprises a mounting adapter for mounting of the drive unit to the flap and that the mounting adapter comprises an adapter interface, with which the mounting adapter is attached to the drive unit and that the mounting adapter comprises a further adapter interface for attachment of the mounting adapter to the flap.

2. The drive arrangement according to claim 1, wherein the mounting adapter is designed separately with respect to the drive unit.

3. The drive arrangement according to claim 1, wherein the mounting adapter is detachably attached to the drive unit.

4. The drive arrangement according to claim 3, wherein the screw connection secures the mounting adapter in its relative axial position in relation to the drive unit.

5. The drive arrangement according to claim 1, wherein a relative rotational movement of the mounting adapter and the unit housing is prevented by an anti-rotation arrangement.

6. The drive arrangement according to claim 5, wherein the anti-rotation element is designed as a recess or as a projection and that the counterpart anti-rotation element is designed as a projection or rather as a recess, wherein the projection engages with the recess, or, that the adapter interface comprises several anti-rotation elements and the unit housing comprises several counterpart anti-rotation elements and that the anti-rotation elements and the counterpart anti-rotation elements are designed such that a gear teeth connection is formed, which prevents the rotational movement of the mounting adapter relative to the unit housing.

7. The drive arrangement according to claim 1, wherein the mounting adapter is attached to the unit housing in a definite relative angular position, which is determined by an angle mounting aid.

8. The drive arrangement according to claim 1, wherein the adapter interface comprises a centering element and that the unit housing comprises a counterpart centering element and that the centering element and the counterpart centering element are in contact such that the relative position of the mounting adapter in relation to the unit housing in a plane, which is orthogonally orientated with regard to the axis of rotation of the output shaft, is determined.

9. The drive arrangement according to claim 1, wherein the adapter interface and the further adapter interface are arranged to each other with an offset, wherein the offset particularly determines the relative attachment position, in which the drive unit can be attached to the flap.

10. A motor vehicle comprising a vehicle body, a flap and a drive arrangement according to claim 1.

11. The method for installing the drive arrangement according to claim 1 to a motor vehicle, wherein the method comprises selecting and/or constructing the mounting adapter under consideration of the structural circumstances.

12. The drive arrangement according to claim 2, wherein the mounting adapter comprises a sheet metal part, or, wherein the mounting adapter comprises a full metal part.

13. The drive arrangement according to claim 3, wherein the mounting adapter is attached to the unit housing by the adapter interface using a screw connection with at least one screw element, and/or, wherein the mounting adapter is attached to the unit housing by the adapter interface using a form-fit connection with at least one form-fit element.

14. The drive arrangement according to claim 4, wherein the screw element is installed in the axial direction of the output shaft, and/or, that the form-fit connection secures the mounting adapter in its relative axial position in relation to the drive unit.

15. The drive arrangement according to claim 5, wherein the adapter interface comprises at least one anti-rotation element and wherein the unit housing comprises at least one counterpart anti-rotation element and that the anti-rotation element and the counterpart anti-rotation element form the anti-rotation arrangement.

16. The drive arrangement according to claim 15, wherein the anti-rotation element and the counterpart anti-rotation element are designed such that a further form-fit connection is formed.

17. The drive arrangement according to claim 7, wherein the anti-rotation element or the anti-rotation elements and the counterpart anti-rotation element or rather the counterpart anti-rotation elements form the angle mounting aid.

18. The drive arrangement according to claim 8, wherein the centering element is designed as a centering recess of the sheet metal part and that the counterpart centering element is designed as a centering projection of the unit housing, or, that the centering element is formed by the anti-rotation elements and the counterpart centering element is formed by the counterpart anti-rotation elements.

19. The drive arrangement according to claim 9, wherein the sheet metal part of the mounting adapter comprises a first section, a middle section and a second section and that the adapter interface is arranged on the first section and the further adapter interface is arranged on the second section and that the middle section connects the first section and the second section, wherein the offset is at least partly determined by the length and/or orientation of the middle section.

20. The method for installing the drive arrangement according to claim 1 to a motor vehicle, wherein the method comprises selecting and/or constructing the mounting adapter under consideration of the structural circumstances regarding the assembly space inside the flap and/or the drive unit and/or the orientation of the flap in relation to the vehicle body.
